(19) United States
(12) Patent Application Publication
(10) Pub. No.: US 2002/0001709 A1
(43) Pub. Date: Jan. 3, 2002

(54) Primer for metallizing substrate surfaces

(76) Inventor: Jochen Voss, Leverkusen (DE)

Correspondence Address: BAYER CORPORATION, PATENT DEPARTMENT, 100 BAYER ROAD, PITTSBURGH, PA, 15205, US

(21) Appl. No.: 09/757,810

(22) Filed: Jan. 10, 2001

(30) Foreign Application Priority Data
Jan. 20, 2000 (DE) 10002102.6

(51) Int. Cl. B32B 27/36; B32B 27/40; B32B 5/16

(52) U.S. Cl. 428/331; 428/411.1; 428/412; 428/328; 428/423.3; 428/423.5; 428/423.7; 428/424.6; 428/424.7; 428/425.6; 428/425.8

(57) ABSTRACT

A primer for the metallization of substrate surfaces by chemical reduction, comprising a) from about 3 to about 40% by weight of a film or matrix former, b) from about 0.1 to about 15% by weight of an additive having a molecular mass of 500 to 20,000, c) from about 0.1to about 15% by weight of an ionic and/or colloidal metal or its organometallic covalent compound or complex compound with organic ligands, d) from about 0.5 to about 30% by weight of an organic and/or inorganic filler, e) from about 0.05 to about 5% by weight of a hydrophilic swelling material comprising finely divided particles containing silanol groups and/or partly modified silanol groups having a diameter of from 7 to 40 nm and a specific surface area of 50 to 380 m²/g, and f) from about 50 to about 90% by weight of organic solvents, in which all amounts by weight being based on the overall primer formulation, offers advantages at low bath loadings.

### FIELD OF THE INVENTION

The invention relates to an improved primer for metallizing substrate surfaces at low bath volume.

### BACKGROUND OF THE INVENTION

It is known that plastics do not possess any shielding from electromagnetic radiation. In order to ensure, in particular, electromagnetic compatibility (EMC) and prevent electromagnetic interference (EMI), plastics must be pretreated chemically by etching processes, such as treatment with chromosulphuric acid followed by seeding with an appropriate activator, before being subsequently metallized by chemical reduction. The pretreatment with such etching media is not selective and owing to their chemical composition—chromosulphuric acid—these media place a heavy burden on the environment.

The person skilled in the art has long been aware of the metallization of acrylonitrile-butadiene-styrene (ABS) copolymers with chromosulphuric acid. Here, the ABS is immersed in the etching medium and thus etched all over. Subsequent seeding with an activator solution comprising palladium permits electroless metallization by chemical reduction.

EP-A 485 839 discloses primers which by masking and subsequent spray application permit selective application of the primer. Electroless metallization of the selectively sprayed plastic takes place exclusively at the points where the primer is applied. Environmentally unfriendly etching media can be omitted. Moreover, plastics which were previously not metallizable may be metallized with the aid of this primer.

The person skilled in the art is also aware that the bath loading of a chemically reductive bath is designated as the area to be metallized per unit bath volume. In general, surface decimeters per liter (dm/l) are specified. Owing to the all-round etching treatment of ABS with chromosulphuric acid, activation and subsequent metallization by chemical reduction, bath loadings of 3-5 dm/l are the rule in the chemically reducing copper bath. Owing to the selectivity, e.g., spraying of a subsection of one side of a plastic, the bath loading is not more than 1 dm/l in the case of practical applications such as, for example, electroless metallization for the shielding of mobile telephones.

A test conducted for firmly adhering metallization is the cross-cut test, which is carried out following electroless metallization of the primer, in accordance with ASTM D 3359-95a or DIN 53 151. Classification of the cross-cut test takes place in accordance with ASTM D 3359-83. In the cross-cut test, 0 B denotes a poor result—no adhesion—and 5 B denotes a very good result—outstanding adhesion.

A disadvantage of the primer disclosed in EP-A 485 839 is that especially at low bath loadings, i.e. less than 1 dm/l, e.g. at 0.2 - 0.4 dm/l, the metallization is not firmly adhering. Especially in the case of ABS or ABS/PC plastics, the cross-test is negative, 0 B (ASTM D 3359-95a). In the case of ABS, no firmly adhering bond between primer and metal is found even at bath loadings of 1 dm/l.

For this reason, primers have now been developed which produce outstanding adhesion of the metal to the primer at low bath loadings, i.e. even in the range of 0.2-0.4 dm/l. Furthermore, the proposed primers exhibit very good behaviour in the cross-cut test; a maximum cross-cut test of 5 B is achieved for ABS plastics classed as problematic.

The object of the invention was to develop selective primers for electroless metallization, including in particular metallizations at low bath loadings, i.e. at bath loadings in the region of less than 0.4 dm/l. There is a particular focus on the firmly adhering, selective electroless metallization of ABS plastics, which are frequently used for parts of housings subject to electromagnetic compatibility. An example is the Bayer ABS plastic type Novodur P2HAT.

### DESCRIPTION

The invention accordingly provides a primer for the metallization of substrate surfaces by chemical reduction, comprising

a) 3 - 40% by weight of a film or matrix former,

b) 0.1 - 15% by weight of an additive having a molecular mass of 500 to 20,000,

c) 0.1 - 15% by weight of an ionic and/or colloidal metals or their organometallic covalent compounds or complex compounds with organic ligands,

d) 0.5 - 30% by weight of an organic and/or inorganic filler,

e) 0.05 - 5% by weight of a hydrophilic swelling material comprising finely divided particles containing silanol groups and/or partly modified silanol groups having a diameter of from 7 to 40 nm and a specific surface area of 50 to 380 m²/g, and

f) 50 - 90% by weight of organic solvents, in which all amounts by weight being based on the overall primer formulation.

Particularly suitable film or matrix formers are the following: surface-coating systems, such as alkyd resins, unsaturated polyester resins, polyurethane resins, epoxy resins, modified fats and oils, polymers or copolymers based on vinyl chloride, vinyl ethers, vinyl esters, styrene, (meth)acrylic acid, acrylonitrile or acrylic esters, cellulose derivatives or stoving enamels which crosslink at a relatively high temperature, examples being polyurethanes formed from hydroxyl-containing polyethers, polyesters or polyacrylates and blocked polyisocyanates, melamine resins formed from etherified melamine-formaldehyde resins and hydroxyl-containing polyethers, polyesters or polyacrylates, epoxy resins formed from polyepoxides and polycarboxylic acids, carboxyl-containing polyacrylates and carboxyl-containing polyesters, stoving enamels comprising polyesters, polyesterimides, polyesteramideimides, polyamideimides, polyamides, polyhydantoins and polyparabanic acids.

Preferably, the film or matrix former comprises a polyurethane.

Film or matrix formers based on polyurethane systems composed of the following components are especially suitable:

1. Aliphatic, cycloaliphatic, araliphatic, aromatic and heterocyclic polyisocyanates, as described for example in Justus Liebigs Annalen der Chemie, 562, pp. 6-136. Particular preference is given to the readily industrially available polyisocyanates, examples being 2,4- and 2,6-tolylene diisocyanate and mixtures of these isomers (TDI), polyphenyl-polymethylene polyisocyanates as prepared by aniline-formaldehyde condensation and subsequent phosgenation (MDI), and polyisocyanates containing carbodiimide groups, urethane groups, allophanate groups, isocyanurate groups, urea groups or biuret groups.

2. Compounds containing at least two isocyanate-reactive hydrogen atoms having a molecular mass of from 400 to 10,000, preferably from1000 to 6000, with particular preference from 2000 to 6000. Reactive hydrogen atoms are those from amino groups, thiol groups, carboxyl groups and, preferably, hydroxyl groups.

3. Further compounds containing isocyanate-reactive hydrogen atoms, which may be used as chain extenders, and also auxiliaries and additives, such as catalysts, surface-active additives and reaction retardants. Such polyurethanes are known and described, for example, in EP-A 485 839.

The film or matrix former may further comprise auxiliaries and additives. Examples of these are:

a) catalysts which promote film formation, e.g. crosslinking catalysts,

b) surface-active additives, e.g. stabilizers and emulsifiers,

c) reaction retardants, e.g. substances having acidic reaction properties, such as hydrochloric acid or acidic organic acid chlorides, and also regulators such as paraffins, dimethyoxysilanes and flame retardants. Also included are stabilizers to counter ageing and to provide weathering stability, and substances possessing fungicidal and bacteriocidal properties. Such auxiliaries and additives are known and are described, for example, in DE-A 2 732 292.

In general, 3 - 40% by weight of the film or matrix former, with particular preference 10 - 30% by weight, are used, based on the overall weight of the primer.

The additives for improving the adhesion of the primer to the plastic are preferably organic and/or organometallic polymers or prepolymers having a molecular mass of from 100 to 1,000,000, preferably between 500 and 20,000. They may, for example, be polymers based on oxazolines such as polyethyloxazoline, polymethyl-, polypropyl- and polybutyloxazoline. Also, oligomeric polymethacrylate acids or their esters. Polyamides based on adipic acid and hexamethylenediamine, polyethyleneamines, polyethyleneamides. Polyesters based on adipic acid, phthalic acid, butanediol and trimethylolpropane. Polyacrylates, such as polyethyl acrylates and polybutyl acrylates. Polyalcohols, such as polyvinyl alcohol, and also mixtures of the aforementioned polymers. Such additives are described, for example, in EP-A 485 839. The amount of the additive that is added is between 0.1 and 15% by weight of the overall weight of the primer.

Suitable activators include ionic and/or colloidal metals or their organometallic covalent compounds or complex compounds with organic ligands. Preference is given to noble metals and their compounds. Particularly preferred noble metals originate from transition groups I and VIII of the Periodic Table of the Elements and are, for example, Pd, Pt, Au and Ag. In general, activators also embrace metal complexes which may be reduced with a reducing agent and which thus permit metallization. With particular preference, these are ionic and/or colloidal metals which permit metallization in alkaline media with the reducing agent formaldehyde or hypophosphite. Acidic media are also possible as the reduction medium. In general, between 0.1 and 15% by weight of the activator, with particular preference between 2 and 5% by weight, are used, based on the overall weight of the primer.

Examples of suitable organic and/or inorganic fillers for primers of the invention are the oxides of the elements Mn, Ti, Mg, Al, Bi, Cu, Ni, Sn, Zn and Si, and also silicates such as bentonites, talc and chalk. Specific examples are pulverized high-melting plastics, carbon blacks, other carbon powders, clay minerals, and titanium oxide. Between 0.5 and 30% by weight of such fillers are added to the primer.

The hydrophilic swelling materials of the invention have the property of dissolving greatly and rapidly in aqueous solutions. The outstanding activity of the hydrophilic swelling substances resides in great and rapid swelling in aqueous solutions, as a result of which the primer rapidly and effectively draws up the aqueous solution and as a result, for example, ions or colloidal particles from the aqueous solution are brought rapidly and uniformly into the primer. Owing to the great swelling of the primer in aqueous solution, it is possible in particular for relatively large—colloidal—copper complexes to penetrate the primer more effectively.

Especially in the case of ABS, low molecular substances may pass from the ABS substrate into the primer. As a result, relatively large—colloidal—copper complexes are unable to penetrate the primer at low bath loadings in the case of primers in accordance with EP-A 485 839. Through the addition of the strongly hydrophilic swelling substance, the primer is able to swell and relatively large—colloidal—copper complexes are able to penetrate into the primer.

Particular features of these swelling substances are extremely finely divided particles containing silanol groups, having a diameter of from 7 to 40 nm and a high specific surface area of from 50 to 380 m²/g. In addition to the silanol groups, it is also possible for partly modified silanol groups, such as siloxane groups, for example, to be present. The swelling materials of the invention may also comprise a combination of particles containing silanol groups and particles containing modified silanol groups. Preferably, the very finely divided particles have a spherical surface, but may also have amorphous forms. Preferably, the hydrophilic swelling substances are added in an amount of from 0.05 to 5% of the primer weight. A particularly preferred range is that from 0.5 to 2.5% of the primer weight.

Examples are the particles designated under the trade name CAB-O-SIL®. This is an extremely finely divided silicon dioxide prepared by a special high-temperature hydrolysis process. It is a synthetic silica. It is also possible to use finely divided particles which possess silanol groups on the surface by virtue of chemical or physical modification. Particularly appropriate here are particles modified by physical vapour deposition (PVD). Examples are pigments coated with silicon dioxide, such as titanium dioxide, for example.

Organic solvents for the primer of the invention are the substances known in printing or coating technology, such as aromatic and aliphatic hydrocarbons, examples being toluene, xylene, benzine; glycerol; ketones, such as methyl ethyl ketone, cyclohexanone; esters, such as butyl acetate, dioctyl phthalate, butyl glycolate; glycol ethers, such as ethylene glycol monomethyl ether, diglyme, propylene glycol monomethyl ether; esters of glycol ethers, such as ethylene glycol acetate, propylene glycol monomethyl ether acetate; diacetone alcohol, N-methylpyrrolidone, N-methylcaprolactam. It is of course also possible to use mixtures of these solvents and blends thereof with other solvents.

The primer of the invention is generally prepared by mixing the constituents. The primer may be applied to the substrate surfaces in accordance with the customary methods, such as printing, stamping, dipping, brushing, knifecoating and spraying, for example.

The coat thickness of the primer may be varied in the range from 0.1 to 200 μm, preferably in the range from 5 to 30 μm. Particularly suitable substrates of the primer of the invention are as follows: acrylonitrile-butadiene-styrene (ABS) polymers, polycarbonate (PC), blends thereof and flame retarded grades, and also polyamide (PA), examples being polyamide 6, polyamide 66, polyesters such as polyethylene terephthalate, polybutylene terephthalate, polyethylene naphthalate, aromatic, liquid-crystalline polyesters, polyvinyl chloride (PVC), polyethylene, polypropylene, polyphenylene sulphide, polyphenylene oxide, polyurethanes, polyimides, polyamideimides, polyetherimide, polysulphones, polyacetals, polystyrene and also copolymers or blends of the aforementioned polymers. Also, the class of the thermosets, such as diallyl phthalate resins (DAP), epoxy resins (EP), urea-formaldehyde resins (UF), melamine-formaldehyde resins (MF), melamine-phenol-formaldehyde resins (MP), phenol-formaldehyde resins (PF), and saturated polyester resins (UP).

Metallic surfaces or glass, and also plastics coatings on metal or glass, are likewise suitable substrates. A further aspect of the invention, therefore, is the use of the primer for the metallization by chemical reduction of plastics surfaces, glass or metal. As such, the metallized substrate that can be prepared in accordance with the invention include a versatile variety.

The invention is further described in the following illustrative examples in which all parts and percentages are by weight unless otherwise indicated.

### EXAMPLES

Metallization was carried out in the commercially available chemically reductive metallizing system “Covertron” from the company Atotech.

Covertron Copper: copper sulphate: 3-5 g/l; NaOH: 6-9 g/l; formaldehyde: 2.5-3.9 g/l; stabilizers in the ppm range; temperature 40-45° C.

Covertron Nickel: Nickel sulphate: 2-5 g/l; hypophosphite 7-10 g/l; stabilizers in the ppm range; pH: 8.0-8.5; temperature 30-45° C.

### Example 1

### Invention

An injection molded plate (10×15 cm) of the ABS plastic Novodur P2HAT (Bayer AG) was sprayed with 25 μm of primer and dried at 75° C. for 60 minutes. The primer comprised 11.2 parts by weight of polyurethane resin in a mixture of 69.6 parts by weight of isopropanol, diacetone alcohol, toluene (1:1:0.5), 2.5 parts by weight of polyester, 2.0 parts by weight of silver oxide, 9.4 parts by weight of talc (>60% by weight silicon dioxide, >20% by weight magnesium oxide), 2.9 parts by weight of chalk, 0.9 part by weight of finely divided silicon dioxide having a diameter of 7 nm and a specific surface area of 300 m²/g as hydrophilic swelling substance, 0.5 part by weight of a silicon-based dispersion medium and 1 part by weight of carbon black.

The plastics plate was immersed for 5 minutes in a waterbath at 60° C. and is subsequently metallized in the commercial metallizing bath “Covertron Copper” at a bath loading of 0.3 dm/l for 60 minutes. Thereafter it was nickel plated in the metallizing bath “Covertron Nickel” at a bath loading of 0.3 dm/l for 10 minutes. The metallized plastics plate was dried at 65° C. for 60 minutes. Cross-cut test in accordance with ASTM D 3359-95a and DIN 53 151 was 5 B.

### Example 2

### Comparison

An injection molded plate (10×15 cm) of the ABS plastic Novodur P2HAT (Bayer AG) was sprayed with 25 μm of primer and dried at 75° C. for 60 minutes. The primer comprised 50 parts by weight of a physically drying 1-component polyurethane resin, 750 parts by weight of a solvent mixture comprising toluene, diacetone alcohol and isopropanol (1:1:1), 55 parts by weight of titanium dioxide, 25 parts by weight of talc (>60% by weight silicon dioxide, >20% by weight magnesium oxide), 25 parts by weight of chalk, 50 parts by weight of a polyamide hot-melt adhesive material (Eurelon 2140) in a 20% strength by weight MEK (methyl ethyl ketone)/DAA (diacetone alcohol) (1:1) solution and 4 parts by weight of silver nitrate. The primer contained no hydrophilic swelling material of the invention.

The plastics plate was metallized in the commercial metallizing bath “Covertron Copper” at a bath loading of 0.3 dm/l for 60 minutes. Thereafter it was nickel plated in the metallizing bath “Covertron Nickel” at a bath loading of 0.3 dm/l for 10 minutes. The metallized plastics plate was dried at 65° C. for 60 minutes. Cross-cut test in accordance with ASTM D 3359-95a and DIN 53 151 was 0 B.

### Example 3

### Invention

An injection molded plate (10×15 cm) of the ABS plastic Novodur P2HAT (Bayer AG) was sprayed with 25 μm of primer and dried at 75° C. for 60 minutes. The primer comprised 50 parts by weight of a physically drying 1-component polyurethane resin, 750 parts by weight of a solvent mixture comprising diacetone alcohol and isopropanol (1:1), 55 parts by weight of titanium dioxide, 25 parts by weight of talc (>60% by weight silicon dioxide, >20% by weight magnesium oxide), 25 parts by weight of chalk, 50 parts by weight of a polyamide hot-melt adhesive material (Eurelon 2140) in a 20% strength by weight MEK/DAA (1:1) solution, 35 parts by weight of iron phosphate, 7 parts by weight of carbon black and 10 parts by weight of spherical silicon dioxide having a diameter of 12 nm and a specific surface area of 200 m²/g as hydrophilic swelling substance.

The plastics plate was metallized in the commercial metallizing bath “Covertron Copper” at a bath loading of 0.3 dm/l for 60 minutes. Thereafter it was nickel plated in the metallizing bath “Covertron Nickel” at a bath loading of 0.3 dm/l for 10 minutes. The metallized plastics plate was dried at 65° C. for 60 minutes. Cross-cut test in accordance with ASTM D 3359-95a and DIN 53 151 was 5 B.

### Example 4

### Invention

Injection molded plates (10×15 cm) of the Bayer AG plastics ABS Novodur P2X, polycarbonate (Makrolon T 7435) and the ABS/polycarbonate blend (Bayblend FR 90) were sprayed with 25 μm of primer and dried at 75° C. for 60 minutes. The primer comprised 75 parts by weight of a physically drying 1-component polyurethane resin, 550 parts by weight of a solvent mixture comprising diacetone alcohol and isopropanol (1:1), 35 parts by weight of titanium dioxide, 15 parts by weight of talc (>60% by weight silicon dioxide, >20% by weight magnesium oxide), 35 parts by weight of chalk, 50 parts by weight of a polyamide hot-melt adhesive material (Eurelon 2140) in a 20% strength by weight MEK/DAA (1:1) solution, 6 parts by weight of silver nitrate, 7 parts by weight of carbon black and 10 parts by weight of spherical silicon dioxide having a diameter of 14 nm and a specific surface area of 150 m²/g as hydrophilic swelling substance.

The plastics plates were metallized in the commercial metallizing bath “Covertron Copper” at a bath loading of 0.3 dm/l for 60 minutes. Thereafter they were nickel plated in the metallizing bath “Covertron Nickel” at a bath loading of 0.3 dm/l for 10 minutes. The metallized plastics plates were dried at 65° C. for 60 minutes. Cross-cut test in accordance with ASTM D 3359-95a and DIN 53 151 was 5 B.

### Example 5

### Invention

An injection molded plate (10×15 cm) of the ABS plastic Novodur P2X (Bayer AG) was sprayed with 25 μm of primer and dried at 75° C. for 60 minutes. The primer comprised 110 parts by weight of a physically drying 1-component polyurethane resin, 790 parts by weight of a solvent mixture comprising diacetone alcohol, butyl acetate and isopropanol (1:1:1), 75 parts by weight of titanium dioxide, 35 parts by weight of talc (>60% by weight silicon dioxide, >20% by weight magnesium oxide), 35 parts by weight of chalk, 25 parts by weight of a polyamide hot-melt adhesive material (Eurelon 2140) in a 20% strength by weight DAA/NMP (1-N-methyl-2-pyrrolidone) (1:1) solution, 6 parts by weight of silver nitrate, 7 parts by weight of carbon black and 7 parts by weight of spherical silicon dioxide having a diameter of 7 nm and a specific surface area of 380 m²/g as hydrophilic swelling substance.

The plastics plate was metallized in the commercial metallizing bath “Covertron Copper” at a bath loading of 0.3 dm/l for 60 minutes. Thereafter it was nickel plated in the metallizing bath “Covertron Nickel” at a bath loading of 0.3 dm/l for 10 minutes. The metallized plastics plate was dried at 65° C. for 60 minutes. Cross-cut test in accordance with ASTM D 3359-95a and DIN 53 151 was 5 B.

TABLE 1
Summary of Examples 1 to 5:

| | Fillers | Swelling | Cross-cut |
|---|---|---|---|
| Primer | (including talc) | substance | test on ABS |
| Example 1 | + | + | 5 B |
| Example 2 | + | − | 0 B |
| comparison | | | |
| Example 3 | + | + | 5 B |
| Example 4 | + | + | 5 B |
| Example 5 | + | + | 5 B |

Although the present invention has been described in detail with reference to certain preferred versions thereof, other variations are possible. Therefore, the spirit and scope of the appended claims should not be limited to the description of the versions contained therein.

What is claimed is:

1. A primer comprising:
(a) from about 3 to about 40% by weight of a film or matrix former,
(b) from about 0.1 to about 15% by weight of an additive having a molecular mass that ranges from about 500 to about 20,000,
(c) from about 0.1 to about 15% by weight of an ionic and/or colloidal metal or its organometallic covalent compound or its complex compound with organic ligands,
(d) from about 0.5 to about 30% by weight of an organic and/or inorganic filler,
(e) from about 0.05 to about 5% by weight of a hydrophilic swelling material comprising finely divided particles containing silanol groups and/or partly modified silanol groups having a diameter that ranges from about 7 to about 40 nm and a specific surface area that ranges from about 50 to about 380 m²/g, and
(f) from about 50 to about 90% by weight of organic solvents, wherein all amounts by weight being based on the overall primer formulation.

2. The primer of claim 1, wherein the film or matrix former comprises polyurethane.

3. The primer of claim 1, wherein the finely divided particles of the hydrophilic swelling substance have a spherical surface.

4. A metallizable substrate comprising:
(a) a substrate,
(b) a primer comprising:
(i) from about 3 to about 40% by weight of a film or matrix former,
(ii) from about 0.1 to about 15% by weight of an additive having a molecular mass that ranges from about 500 to about 20,000,
(iii) from about 0.1 to about 15% by weight of an ionic and/or colloidal metal or its organometallic covalent compound or its complex compound with organic ligands,
(iv) from about 0.5 to about 30% by weight of an organic and/or inorganic filler,
(v) from about 0.05 to about 5% by weight of a hydrophilic swelling material comprising finely divided particles containing silanol groups and/or partly modified silanol groups having a diameter of from 7 to 40 nm and a specific surface area of 50 to 380 m²/g, and
(vi) from about 50 to about 90% by weight of organic solvents, wherein all amounts by weight being based on the overall primer formulation.

5. A metallized substrate comprising the reaction product of:
(a) a substrate,
(b) a primer comprising:
(i) from about 3 to about 40% by weight of a film or matrix former,
(ii) from about 0.1 to about 15% by weight of an additive having a molecular mass that ranges from about 500 to about 20,000,
(iii) from about 0.1 to about 15% by weight of an ionic and/or colloidal metal or its organometallic covalent compound or its complex compound with organic ligands,
(iv) from about 0.5 to about 30% by weight of an organic and/or inorganic filler,
(v) from about 0.05 to about 5% by weight of a hydrophilic swelling material comprising finely divided particles containing silanol groups and/or partly modified silanol groups having a diameter of from 7 to 40 nm and a specific surface area of 50 to 380 m²/g, and
(vi) from about 50 to about 90% by weight of organic solvents, wherein all amounts by weight being based on the overall primer formulation.

6. The metallized substrate of claim 5, wherein the substrate comprises a plastic substrate.

7. The metallized substrate of claim 5, wherein the substrate comprises a glass substrate.

8. The metallized substrate of claim 5, wherein the substrate comprises a metallic substrate.

9. The metallized substrate of claim 5, wherein the substrate is selected from the group consisting of acrylonitrile-butadiene-styrene polymers, polycarbonates, polyamides, polyesters, polyvinyl chloride, polyethylene, polypropylene, polyphenylene sulphide, polyphenylene oxide, polyurethanes, polyimides, polyamideimides, polyetherimide, polysulphones, polyacetals, polystyrenes, thermosets, blends of the aforementioned polymers, and copolymers the aforementioned polymers.
